(19) United States
(12) Patent Application Publication
(10) Pub. No.: US 2010/0064320 A1
(43) Pub. Date: Mar. 11, 2010

(54) Integrating data on program popularity into an on-screen program guide

(75) Inventors: Joel Angiolillo, Weston, MA (US); Jordan Kanarek, Brookline, MA (US)

Correspondence Address: VERIZON;PATENT MANAGEMENT GROUP, 1320 North Court House Road, 9th Floor, ARLINGTON, VA, 22201-2909, US

(73) Assignee: Verizon Services Corp., Arlington, VA (US)

(21) Appl. No.: 11/373,178

(22) Filed: Mar. 13, 2006

(51) Int. Cl. H04N 5/445

(52) U.S. Cl. 725/46

(57) ABSTRACT

A subscriber to a digital cable or satellite TV service generally has available to them an on-screen program guide. The program guide lists programming (e.g., TV shows) that are available to the subscriber for a certain upcoming time period, typically two weeks. The programming guide may sort the listings by channel and time, areas of interest, age appropriateness and/or MPAA or TV rating, free or additional cost, etc. In the embodiments of the present invention, the programming guide includes an ability to make a selection to see which TV shows are currently (or typically) most watched. In one embodiment, this information is presented as a simple “top 10” list by displaying the actual number of television sets having a set top box with an integrated internet protocol (IP) channel that are tuned to that program. In other embodiments, other web-based services (e.g., Nielsen Ratings) are accessed to determine the popularity of television shows. Results may be provided audibly and/or graphically on a subscriber's television display.

### BACKGROUND INFORMATION

Customers (a/k/a “subscribers”) of modern cable or television (TV) satellite services are familiar with the concept of an on-screen programming guide or an interactive program guide (IPG). These program guides allow a subscriber to display, sort and search TV programming that is playing on the channels available to the subscriber. Typically, when a subscriber accesses the program guide, the programs on at that moment are displayed. The user can generally scroll forward in time to see what is playing later in the day, on the next day, and further ahead in time. A typical program guide allows a subscriber to display programming up to two weeks into the future.

Today's television services provide hundreds of channels to chose programming content from, including movies and pay-per-view events. In the future, it is expected there will be thousands of channels. In order to make selections when faced with such a multitude of options, a subscriber may go to a magazine, newspaper or website to see what TV programs and movies are the most popular. Depending upon their preferences, subscribers may rely upon specific sources to determine popularity, such as, for example, Nielsen ratings from Nielsen Media Research of New York, N.Y. However, there presently is not any information concerning the popularity of the programs offered in these guides that are available while a subscriber is perusing the on-screen program guide.

### BRIEF DESCRIPTION OF THE DRAWING(S)

FIG. 1a is an illustration of one embodiment of a computing device that can be used to practice aspects of the present invention;

FIG. 1b is an embodiment of a processing system having a distributed communication and processing architecture that may be used to practice aspects of the present invention;

FIG. 2 is an illustration of an exemplary network architecture that may be used to practice one or more embodiments of the present invention;

FIGS. 3A-3F are exemplary television or display device screenshots showing the process of obtaining and displaying programming popularity information in an embodiment of the present invention;

FIG. 4 illustrates an exemplary process for providing a user with television programming popularity information while the user is interacting with an on-screen programming guide, in an embodiment of the present invention;

FIG. 5 illustrates an exemplary process for a user to access programming popularity information as such information is integrated into an interactive program guide, in an embodiment of the present invention; and

FIG. 6 is another embodiment of an exemplary process for providing a user with programming popularity information from one or more sources while the user is interacting with an on-screen programming guide.

### DETAILED DESCRIPTION OF THE PREFERRED EMBODIMENTS

Preferred embodiments that may be implemented according to the present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

The preferred embodiments described herein provide systems and methods for a subscriber to make a selection from their on-screen program guide to see the popularity of available programming content. Popularity information and programming options may be brought together on a TV screen for a viewer's convenience and use. Additionally, the preferred popularity information can be applied to other directories such as, for example, video on demand movies, online games, movies currently playing in theaters, etc.

As will be appreciated by one skilled in the art, the preferred embodiment may be implemented as a method, a data processing system, or a computer program product. Accordingly, the preferred embodiment may take the form of an entirely hardware embodiment, an entirely software embodiment, or an embodiment combining software and hardware aspects. Furthermore, implementations of the preferred embodiment may take the form of a computer program product on a computer-readable storage medium having computer-readable program instructions (e.g., computer software) embodied in the storage medium. More particularly, implementations of the preferred embodiments may take the form of web-implemented computer software. Any suitable computer-readable storage medium may be utilized including hard disks, CD-ROMs, optical storage devices, or magnetic storage devices.

The preferred embodiments according to the present invention are described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

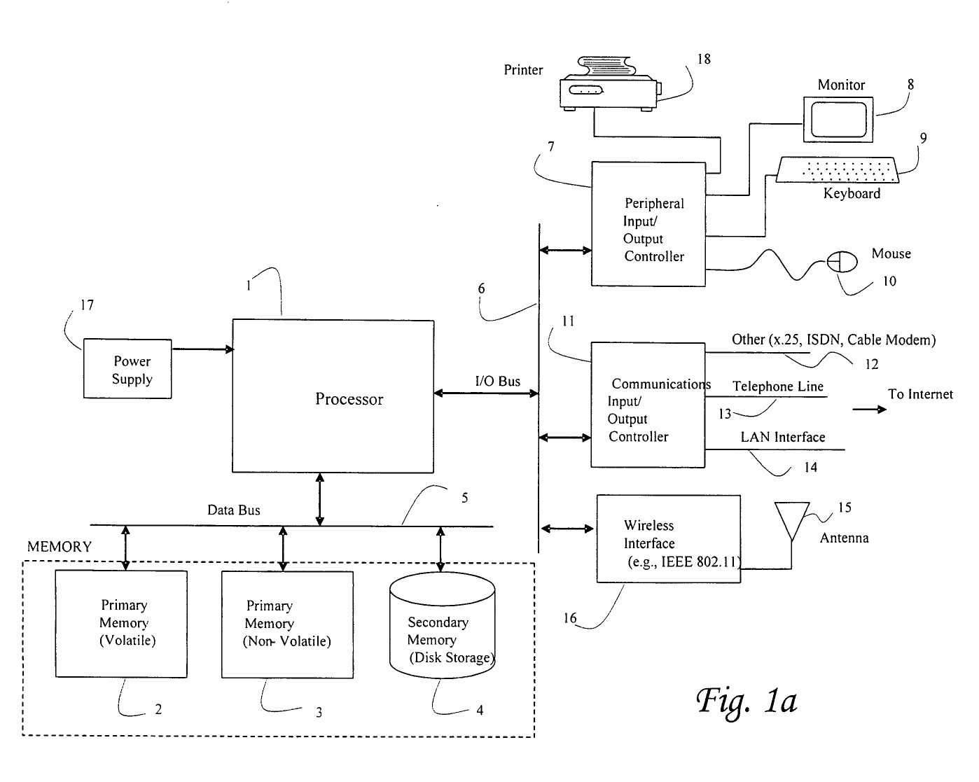

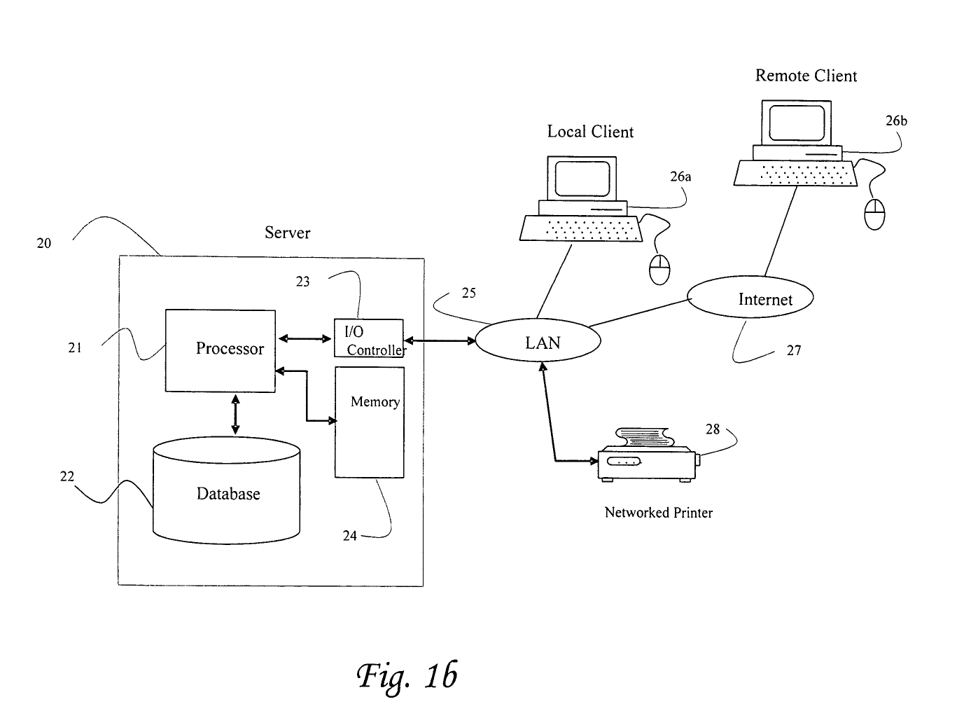

In the preferred embodiments referenced herein, a “computer” or “computing device” may referenced. Such computer may be, for example, a mainframe, desktop, notebook or laptop, a hand held device such as a data acquisition and storage device, or it may be a processing device embodied within another apparatus such as, for example, a set top box for a television system or a wireless telephone. In some instances the computer may be a “dumb” terminal used to access data or processors over a network. Turning to FIG. 1a, one embodiment of a computing device is illustrated that can be used to practice aspects of the preferred embodiment. In FIG. 1a, a processor 1, such as a microprocessor, is used to execute software instructions for carrying out the defined steps. The processor receives power from a power supply 17 that also provides power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4, such as disk storage, that stores large amount of data. In some embodiments, the disk storage may communicate with the processor using an I/O bus 6 instead or a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access a wide area network such as the Internet, intranets, LANs, or other data communication facilities.

Finally, the processor 1 may communicate with a wireless interface 16 that is operatively connected to an antenna 15 for communicating wirelessly with another device, using for example, one of the IEEE 802.11 protocols, 802.15.4 protocol, or a standard 3G wireless telecommunications protocols, such as CDMA2000 1x EV-DO, GPRS, W-CDMA, or other protocol.

An alternative embodiment of a processing system that may be used is shown in FIG. 1b. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor also communicates with external devices using an I/O controller 23 that typically interfaces with a LAN 25. The LAN may provide local connectivity to a networked printer 28 and the local client computer 26a. These may be located in the same facility as the server, though not necessarily in the same room. Communication with remote devices typically is accomplished by routing data from the LAN 25 over a communications facility to a wide area network 27, such as the Internet. A remote client computer 26b may execute a web browser, so that the remote client 26b may interact with the server as required by transmitted data through the wide area network 27, over the LAN 25, and to the server 20.

Those skilled in the art of data networking will realize that many other alternatives and architectures are possible and can be used to practice the preferred embodiments. The embodiments illustrated in FIGS. 1a and 1b can be modified in different ways and be within the scope of the present invention as claimed.

The preferred embodiments provide for popularity information about certain video programming to be stored by a popularity information system as referenced hereinafter. This information may be obtained from other sources such as, for example, the Nielsen Ratings that are available at www.nielsenmedia.com, or it may be derived from empirical data such as by the system polling computing devices capable of providing viewing information and/or a history of viewing information to the system. This information may be periodically or continuously updated on the system. When a customer makes a selection while viewing, for example, a program guide, a request is made to the popularity information system, which then transmits the popularity information to the customer's computing device (e.g., a set top box), where it may be displayed to the customer.

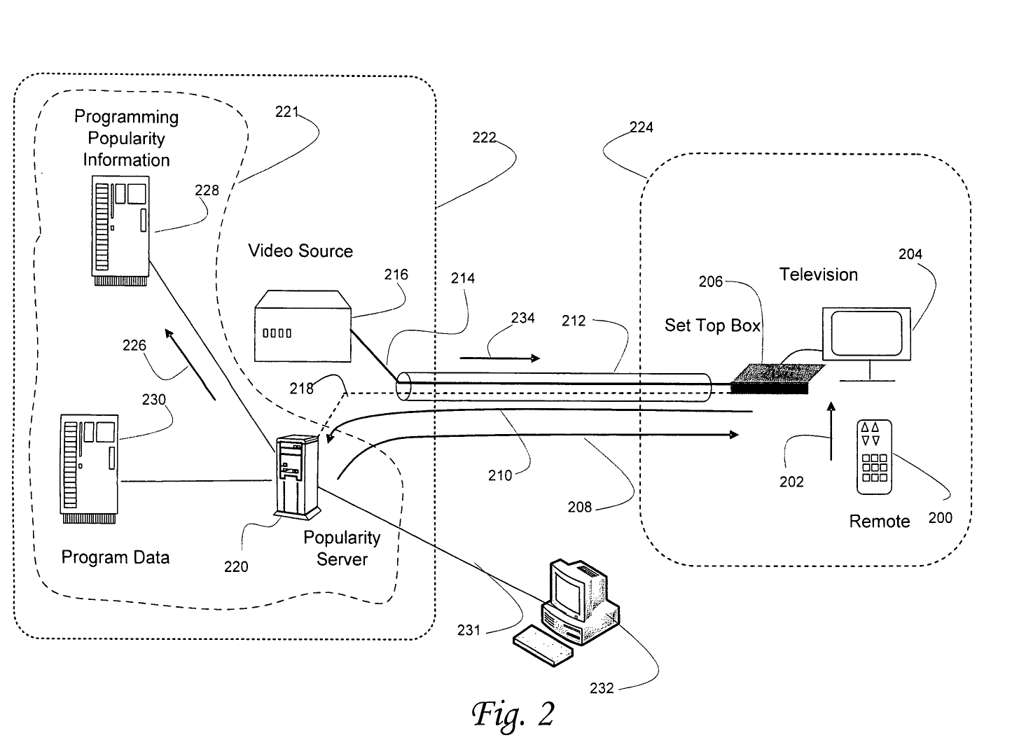

An embodiment of network architecture that may be associated with an on-screen program guide with interactive program popularity information is shown in FIG. 2. In FIG. 2, a user, customer or subscriber 224 to a service provider 222 comprises a computing device such as, for example, a set top box 206, a monitor or other display device such as, for example, a television 204, and an input device such as, for example, a remote controller (remote) 200. The remote 200 is used to provide selection input, which is received by the set top box 206. Alternatively, input can be provided to the set top box 206 without utilization of a remote, such as by depressing keys incorporated into the set top box 206, or by other means as are known in the art. The set top box 206 includes an output interface facility that provides video signals to television 204 (in known formats). The set top box 206 also includes a network interface facility that is configured to communicate with the service provider over an access network 212. The set top box 206 recognizes multiple types of communications from the service provider, such as bidirectional data communications, which may be implemented as an Internet Protocol (IP) channel 218, and multicast/broadcast video communications, which may be implemented as one or more quadrature amplitude modulation (QAM) video channels 214. The service provider 222 may include one or more video source systems 216 (e.g., a headend), as well as other network elements, which provide video content to access network 212. Service provider 222 may also include a popularity information system 221, as further described below.

Although FIG. 2 illustrates a single video source system 216 and a single subscriber 224, there are typically numerous subscribers and/or network elements within a system. Thus, although the QAM channel 214 is illustrated as point-to-point, it may actually be a broadcast channel in a point-to-multipoint configuration. The IP channel, however, can be viewed as a point-to-point configuration. The other subscribers and network elements are not shown in FIG. 2 for clarity reasons.

The IP channel 218 provides a separate channel for bi-directional communication between the set top box 206 and the service provider. Specifically, the IP channel 218 in this embodiment provides access to popularity information system 221, which is able to provide popularity information to the set top box 206. Furthermore, the IP channel 218 allows feedback from the set top box 206 to be provided to the system 221 to provide real-time and historical information about the shows being watched by the user. In one embodiment, the set top box 206 overlays a window of popularity information (i.e., a popularity window) on the video data when presenting the video signal to the television, though in other embodiments the popularity information is combined with the video signal provided by the service provider. Techniques for overlaying or combining displays are known in the art.

The QAM channel 214 carries video information from video source system 216. Although the QAM channel is illustrated as a single channel, there are typically multiple channels provided over an access network. Typically, additional equipment is required to multiplex and otherwise process a variety of video channels onto the access network (e.g., modulators, amplifiers, etc.) and FIG. 2 illustrates only a single video source system for purposes of clarity.

The popularity information system 221 may be implemented using a popularity information server 220, a program data storage 230, and a popularity processor 228. The popularity information server 220 may be implemented to include, for example, a web (HTTP) server or other communications protocol that allows for communications between server 220 and subscribers 224 over the access network 212. The popularity information server 220 has access to program data storage system 230, which stores program data, such as program guide information associated with the various programs available over the access network. The system 230 contains information regarding what programs are currently being provided by the video source 216 and at what times. It is presumed that infrastructure is in place (not shown) for automatically updating the system 230 with the appropriate information. Thus, the popularity server 220 can query (or otherwise obtain) information about which specific programs are being provided on the access network 212. This may include which programs are available on which channels. The server 220 may also have an interface 231 to allow a trusted source 232 to enter popularity data about a particular show. In other embodiments, the popularity server may be programmed to search or reach out to specified websites such as the Nielsen data website, to obtain popularity data from various sources. The server 220 may also be connected to popularity processor 228, which may be a computer configured to store and process popularity data from various sources. It is to be appreciated that one or more of the popularity information server 220, the popularity processor 228 and the program data storage system 230 may be implemented in the same computer (e.g., as separate processes) or separate computers. The popularity information can be stored on the popularity processor 228 and integrated into the data communicated over access network 212 so that viewers or potential viewers of the program would be able to see the popularity of a selected program. In such a case, the system 228 provides the popularity information to the server 220 which transmits it to the set top box 206 and the set top box 206 displays it on the television screen 204.

An embodiment of the typical information flow for processing a request for a review of popularity content is now described in the context of FIG. 2. A user has made a selection that allows the user to review an on-screen program guide as such are known in the art to determine programming content that is currently available to the user over access network 212 (and may be available in the future). The user may also make a selection to review the popularity of programming content that is available to the user. This may be accomplished by selecting an icon on the on-screen program guide, by making a selection on the set top box 206 separate from the on-screen program guide, or by indicating in some manner by a user action that the user wishes to see the popularity of current programming content. The user's action, which may be performed by a function key (or some other keypad indication) on the remote 200, indicates a request for programming popularity to the set top box 206. The set top box 206 ascertains the currently available programming content and programming content that will be available in the future and sends a message 210 to the popularity server 220 over the IP channel 218 indicating the programming popularity request. The request may includes various information, such as a set top box identifier and selection criteria (further described below).

The server 220 accesses the program data in system 230 to ascertain the available programs (current and in the immediate future). (Alternatively, the data could have been previously stored in the popularity server.) The server 220 provides a transmission 208 to the set top box 206 indicating program guide information for the available and upcoming programming content (alternately, such information could be provided to set top box 206 previously and stored, such as on a daily basis). The set top box 206 sends message 210 to the server 220, where message 210 may include selection criteria for the populations information (further described below). Server 220 may then send the selection criteria in a request 226 to popularity processor 228, which retrieves popularity information associated with the programming content, for example, using the selection criteria. Alternatively, the message 210 could be sent directly from the set top box 206 to the system 228 where popularity information associated with the programming content can be retrieved. Also alternatively, the selection criteria could be sent directly from the popularity information server 220 to the system 228 without receiving message 210, where the selection criteria are predefined and/or default criteria (e.g., most popular programs for the past seven days). This popularity information is then provided to the set top box 206 in a transmission 234, where it may be displayed, for example, as an overlay of the video image generated by the video signal. If equipped with the proper recording equipment (e.g., digital video recorder), the user may be provided with an option to record the selected popular program at the set top box 206 for playback at the user's convenience.

Alternative embodiments to the system described above are possible. For example, in FIG. 2, the programming popularity information was provided via the IP channel 218 to the set top box 206. In other embodiments, the server 220 may provide the data from which a popularity window may be generated in a video signal and provides the information to the video source system 216 which distributes the information in video form as a separate channel on the access network. (This additional channel is not shown in FIG. 2). The user views the popularity window by having the set top box 206 select the popularity channel and displaying the results to the user using, for example, picture-in-picture techniques. This allows the popularity information to be processed as a separate video feed and displayed using the picture-in-picture capabilities in the television or other display device 204.

The set top box 206 may record the user's request for popularity information, as well as shows selected and/or received by a user, and keep a history of the viewer's actions. This information may be automatically conveyed to the server 220, or retained in the set top box 206 for future downloading to the server 220. The usage information may be stored and processed in the processor 228 in order to track viewership, popularity, etc., for example, on a real-time basis. The usage information in the popularity server may be periodically ‘pulled’ or ‘pushed’ to another computer system that generates periodic bills, in order to properly bill the viewer for such services, if billing is desired. Such information may also be used to determine the preferences of a user so that the user may be proactively notified of the popularity of recently-viewed or repetitively-viewed shows without the user having to request such information.

Selection criteria may be any information that may be used to select a subset of popularity information to provide to subscriber. For example, in the preferred system, a user may be able to: select one or more particular programs and view popularity information for just the selected programs; select a program type (e.g., a genre, such as sitcoms) and view popularity information for all programs having the program type; select a video channel and view popularity information for shows on that channel; select a date range and/or time range and view popularity information for shows within that range; or any combination of the foregoing. The selection criteria may also give an option to provide real-time popularity information vs. historical information (described below). The selection criteria may be included in the message from set top box 206 to server 220 requesting popularity information, or may be default or predefined selection criteria (e.g., the most popular shows over the past seven days) that may be stored or used automatically by server 220.

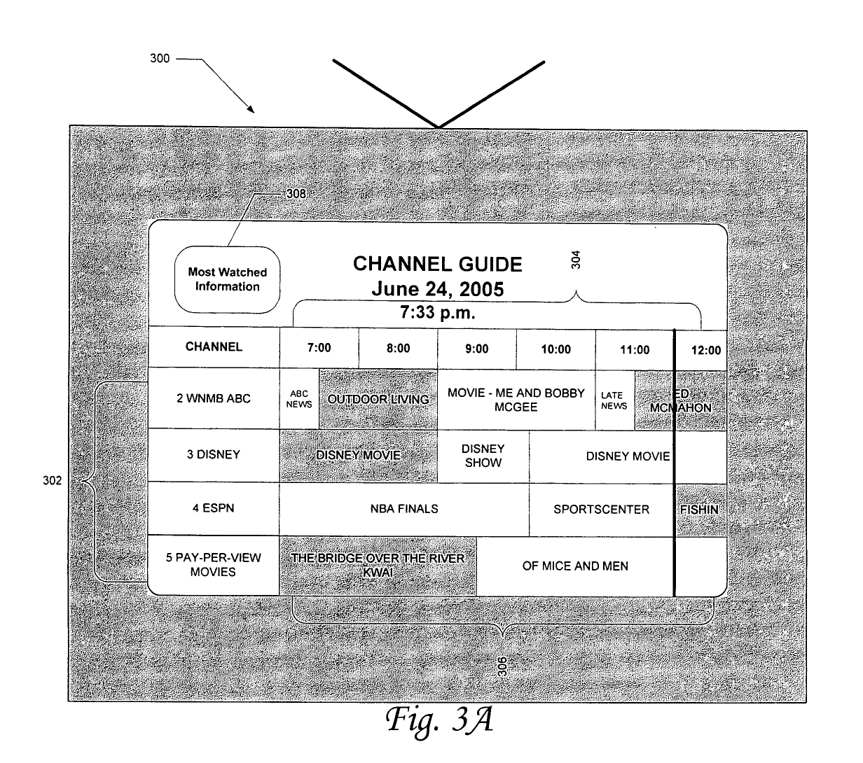

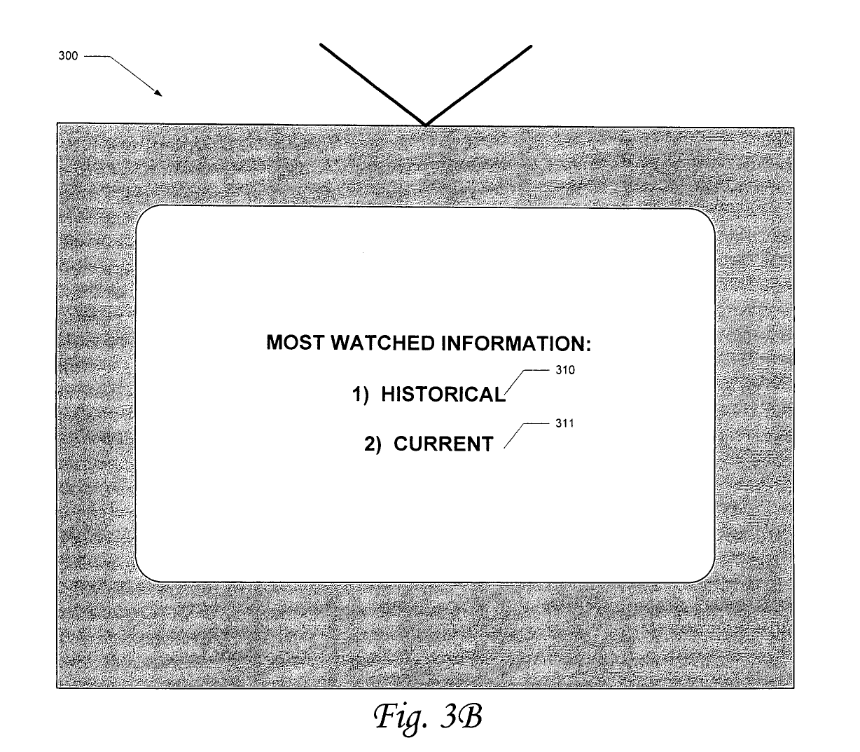

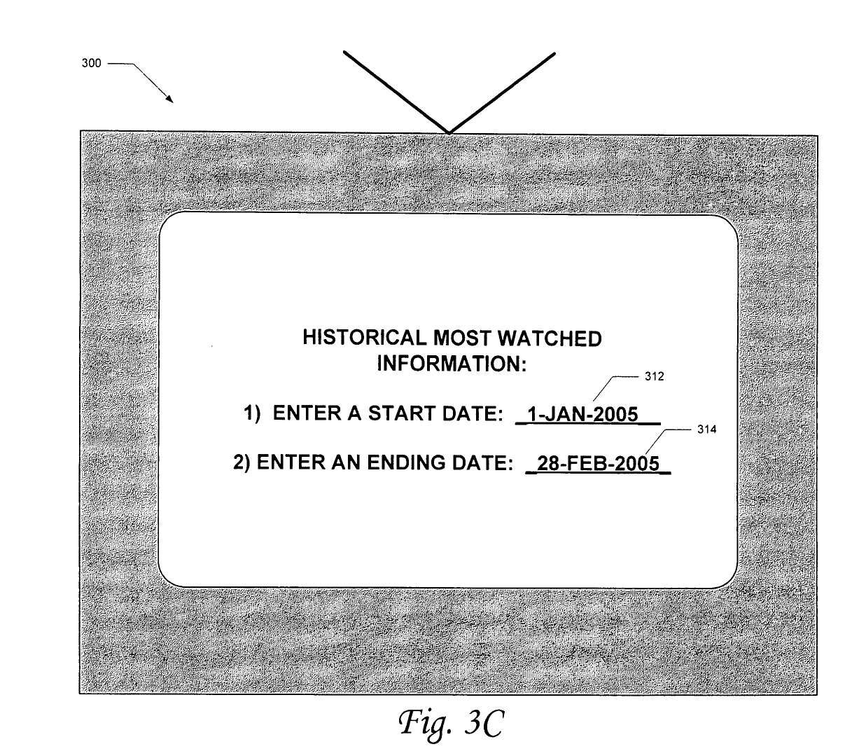

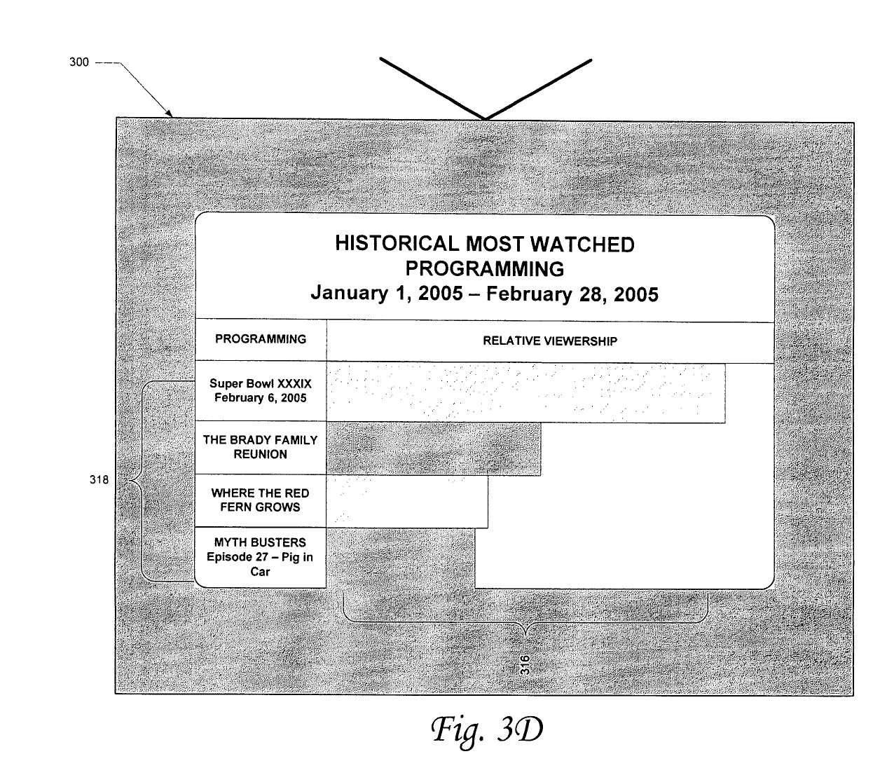

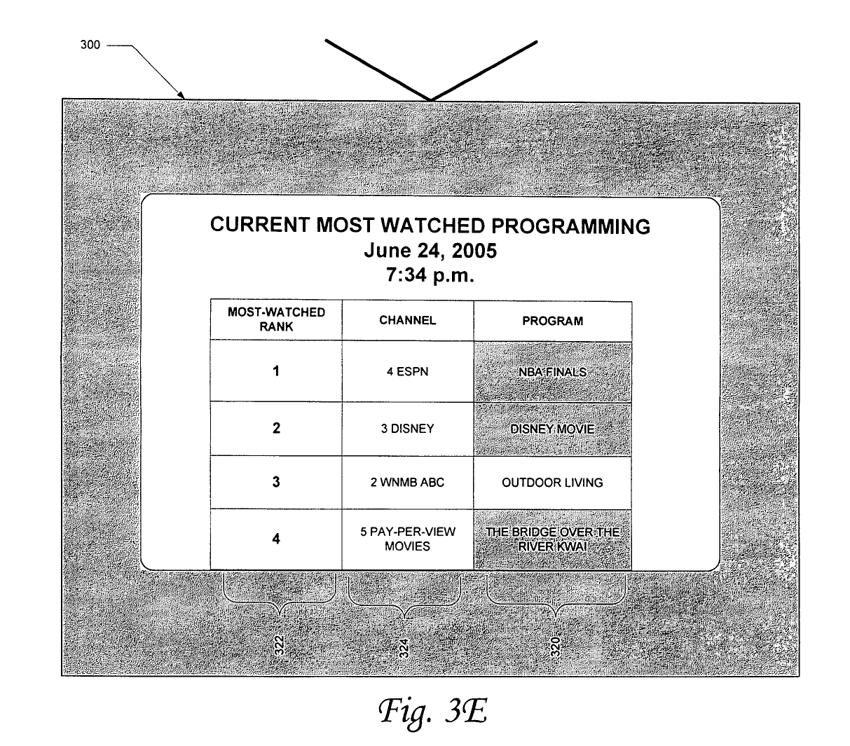

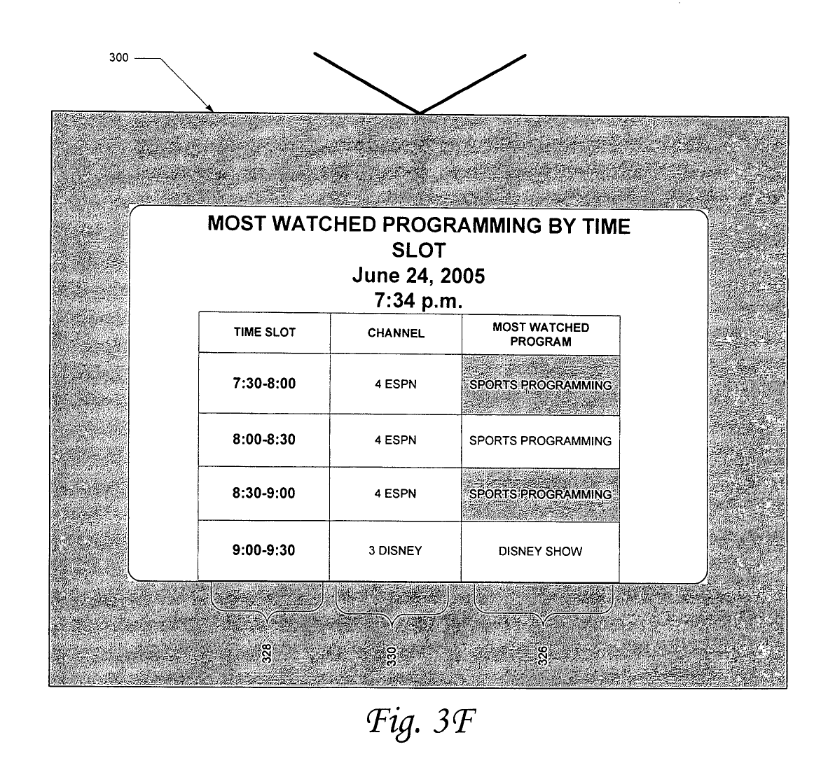

FIGS. 3A-3E are exemplary screenshots of a television or other display device showing the process of obtaining programming popularity information in embodiments of the present invention. In FIG. 3A an action by the user such as, for example, pressing a function key on the remote 200 has caused an on-screen channel guide 300 comprised of a combination of channels 302, time slots 304, and programming content 306 to be displayed on the screen 300. Furthermore, in the preferred embodiment, the user has the option to make a selection 308 from the channel guide screen 300 to obtain “most watched” or popularity information about available programming. The user may make such a selection 308 by pressing a function key on the remote 200, by using the remote to highlight the selection 308 and pressing an “enter” key on the remote 200, or otherwise indicating that the user wants to access “most watched” information. If the user selects the “most watched information” selection 308, then a screen is displayed similar to the exemplary one shown in FIG. 3B, where the user is provided with some selection criteria options regarding most watched television programming, including historical information 310 and current information 311. If, in FIG. 3B, the user selects to review historical popularity or most watched information 310, then the user is provided access to a screen similar to that shown in FIG. 3C which allows specification of additional selection criteria. In the embodiment of FIG. 3C, a user is able to obtain historical “most watched” information for programming between two dates. In one embodiment, the date range may be limited to avoid archiving extensive amounts of back data. For instance, the user may be limited to retrieving “most watched” information for only the past six months from the present date. In FIG. 3C, the user can enter a starting date 312, and an ending date 314. The dates may be entered, for example, by use of the remote 200, though other means are contemplated.

Once the dates are entered, the selection criteria are transferred from the set top box 206 to the server 220, for example, as part of message 210. The popularity server then accesses the system 228 to obtain popularity information for programming using the selection criteria—in this example, the most popular programming available over the access network between the two dates. The popularity or “most watched” information is then transferred from the system 228 to the server 220 and downloaded to the set top box 206, where it is displayed to the user on the user's display device 204 (e.g., television). An exemplary screen illustrating a form of displaying the results for the “most watched” programming between the two dates is shown in FIG. 3D. In the embodiment of FIG. 3D, a bar graph 316 is used to show the relative viewership of programming 318 that was available between the dates provided. It is to be appreciated that many different forms of representing the viewership information may be used, including lists, pie charts, line graphs, audible information, etc.

Referring back to FIG. 3B, if the user selected current “most watched” information 311, then selection criteria indicating real-time popularity information are transferred from the set top box 206 to the server 220, for example, as part of message 210. The popularity server then accesses the system 228 to obtain popularity information for programming using the selection criteria—in this example, the most popular programming currently available over the access network. Present viewership may, in one embodiment, be determined by use of set top boxes at subscribers 224 capable of providing real-time feedback about programs being viewed by a user, such as the set top box described above. As described above, present viewership information is obtained from users' set top boxes 206 through the popularity information server 220 and collected and processed by the popularity processor 228. In other embodiments, present viewership may be obtained from websites or services that monitor the viewing habits of the users. The popularity or “most watched” information is then transferred from the system 228 to the server 220 and downloaded to the set top box 206, where it is displayed to the user on the user's display device 204 (e.g., television), which may take the form of a screen similar to the one shown in FIG. 3E, where currently-available programming 320 is ranked 322 according to the present viewership. Also shown is the channel 324 on which the ranked shows are currently being shown.

Another embodiment of a screen for displaying “most watched” information is shown in FIG. 3F, which is historical based, and shows the most popular programs 326 by the time slots 328 in which the programs are shown and their respective channels 330.

The embodiment of FIGS. 2 and 3A-3F is but one example of many different ways that the preferred systems and processes can be implemented. It is to be appreciated that there are several ways that the channel guide may be displayed as well as various ways to make selections that are displayed on the screen and to be made aware of programming popularity information. For instance, in one embodiment voice commands rather than a remote may be used to make screen selections and information may be visually displayed on the screen(s) or it may be audible, or combinations thereof.

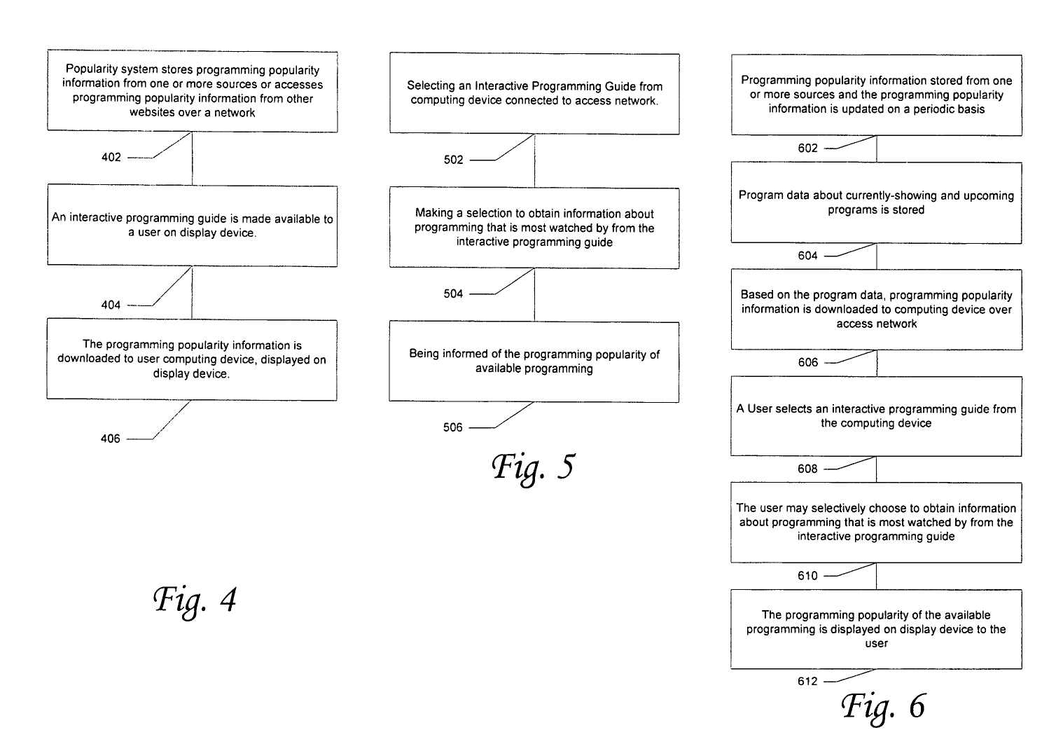

The preferred embodiments of the system described above may be used to provide a user with most watched programming content as a feature of an interactive program guide, as further described in the processes described herein. FIG. 4 illustrates a process for providing a user with most watched or most popular television programming while the user is interacting with an on-screen programming guide. In Step 402 of FIG. 4, a popularity information system is provided where programming popularity information from one or more sources is stored, processed and made available for retrieval. The programming popularity information may be entered by the one or more sources through an interface such as a web interface, or the system may obtain the programming popularity information from one or more other websites, or the system may obtain the information by polling user video-receiving computing devices (e.g., set top boxes) accessible to the system over the access network. At Step 404, the user is provided an interactive programming guide via the computing device and a display device connected thereto, which allows the user to be informed of the one or more available programming options, at a request initiated by the user. At Step 406, the programming popularity information is downloaded to the user's computing device, for example, when such information is selectively chosen by the user. In various embodiments, the programming popularity information may be overlayed over or combined with the video image included in the video signal from the set top box to the display device. The display device may be a television, a monitor, etc.

FIG. 5 describes a process for a user to access programming popularity information. At Step 502, a user selects an interactive program guide from a video-receiving computing device (e.g., a set top box) that is connected to a display device, and the interactive program guide is displayed on the display device (e.g., television). At Step 504, the user makes a selection to obtain information about programming that is most watched by selecting an icon or using other selection means as are known in the art and that may be made known to the user as part of the interactive programming guide. The selection may include various selection criteria, and may be sent to the popularity information system. At Step 506, and as a result of the selection made in Step 504, the user is made aware of the programming popularity (i.e., “most watched”) of the programming available to the user. In one embodiment, the user may view a historical collection of popularity information. In another embodiment, the user is provided the popularity information for video programming that is currently being provided over the access network. The user may also be able to go directly to a showing of the programs described in the popularity information.

FIG. 6 is another embodiment of a process for providing a user with television programming popularity information from one or more sources while the user is interacting with an on-screen programming guide. In Step 602 of FIG. 6, a popularity information system is provided where programming popularity information of the one or more sources is stored, processed and made accessible to video-receiving computing devices (e.g., set top boxes) attached to the access network and also connected to display devices (e.g., televisions). The programming popularity information includes identifying information about a program and information about the number of users tuned to that program during one or more showings of the program. The programming popularity information is updated on a periodic basis to reflect the changing programming content over time. At Step 604, program guide data about current and upcoming program content is stored on the popularity information system. At Step 606, and based upon the program guide data, programming popularity information from the one or more sources is downloaded to one of the video-receiving computing devices attached to the access network. At Step 608, a user selects to view an interactive programming guide from the computing device. At Step 610, the user selectively chooses to review program popularity information from the one or more sources made available to the user as part of the interactive programming guide. And, at Step 612, the programming popularity information is displayed on the display device to the user.

### Modifications and Alternative Embodiments

Many modifications and other embodiments will come to mind to one skilled in the art having the benefit of the teachings presented in the foregoing descriptions of the preferred embodiments. For instance, the popularity information may be provided audibly rather than (or in addition to) visually. Also, the popularity information may be presented in formats that are not shown herein. Accordingly, it should be understood that the invention is not to be limited to the specific embodiments described herein, but rather to the appended claims, and that modifications and other embodiments are intended to be included within the scope of the appended claims. Although specific terms are employed herein, they are used in an inclusively descriptive sense only and not for purposes of limitation.

1. A system comprising:
a provider system including a source of a plurality of video programs, program guide information associated with the plurality of video programs, and a popularity information system storing programming popularity information associated with the plurality of video programs, the provider system configured to transmit the plurality of video programs and the program guide information over an access network connected to the provider system; and
a subscriber computing device connected to the provider system via the access network, wherein said subscriber computing device is configured to receive at least one video program of the plurality of video programs and the program guide information over the access network, display selection criteria for selecting a subset of the programming popularity information, receive the subset of the programming popularity information over the access network, and provide a signal to a display device that includes at least the subset of the programming popularity information.

2. The system of claim 1, wherein said subscriber computing device is a set-top box.

3. The system of claim 1, wherein the popularity information system includes a server, wherein said server is connected to the subscriber computing device over the access network and configured to receive the subset of the programming popularity information and provide the subset of the programming popularity information over the access network to the subscriber computing device upon request by a user of the subscriber computing device.

4. The system of claim 1, wherein said subscriber computing device is further configured to receive the at least one video program via at least one video channel over the access network, and to receive the subset of the programming popularity information from a specified website.

5. The system of claim 1, wherein the subscriber computing device is further configured to send a request to the popularity information system for the subset of the programming popularity information after selection of the selection criteria by a user of the subscriber computing device, and wherein the popularity information system is further configured to transmit the subset of the programming popularity information in response to the request.

6. The system of claim 1, wherein the selection criteria comprises at least one selectable option to view at least one of programming popularity information for a selected number of programs, programming popularity information for a selected program type, programming popularity information for a selected video channel, programming popularity information for a selected date range, programming popularity information for a selected time range, historical popularity information, and real-time popularity information.

7. The system of claim 1, wherein said subset of the programming popularity information includes at least one identifier corresponding to at least some of the plurality of video programs, and data related to a number of viewers receiving the plurality of video programs over a certain period of time.

8. A system comprising:
a network interface to an access network, the network interface configured to receive at least one video program of a plurality of video programs available over the access network and receive program guide information associated with the plurality of video programs over the access network;
an output interface to a display device, the output interface configured to provide a video signal to the display device; and
a processing system connected to the network interface and the output interface, the processing system configured to receive and store the program guide information, provide the program guide information to the output interface for inclusion in the video signal to said display device, display selection criteria on the display device for selecting a subset of programming popularity information, receive a first request for the subset of the programming popularity information associated with the plurality of video programs, provide a second request indicating the requested subset of the programming popularity information to the network interface for transmission over the access network, receive the requested subset of the programming popularity information from the network interface in response to the second request, and provide the requested subset of the programming popularity information to the output interface for inclusion in the video signal to said display device.

9. The system of claim 8, wherein the network interface, output interface and processing system are within a set-top box.

10. The system of claim 8, wherein said network interface is configured to receive the at least one video program via at least one video channel over the access network, and to receive the subset of the programming popularity information from a specified website.

11. The system of claim 8, wherein the second request includes at least one of an identifier of a video program and a subscriber selected time period.

12. The system of claim 8, wherein the output interface is configured to provide the subset of the programming popularity information to the display device by overlaying the subset of the programming popularity information over an image included in the video signal to the display device.

13. The system of claim 8, wherein the selection criteria includes at least one selectable option to view at least one of programming popularity information for a selected number of programs, programming popularity information for a selected program type, programming popularity information for a selected video channel, programming popularity information for a selected date range, programming popularity information for a selected time range, historical popularity information, and real-time popularity information.

14. A method comprising:
providing a plurality of video programs for transmission over an access network;
receiving programming popularity information associated with the plurality of video programs;
providing program guide information over the access network, the program guide information associated with the plurality of video programs;
displaying selection criteria for selecting a selected amount of programming popularity information;
receiving an indication to provide the selected amount of the programming popularity information based on the selection criteria over the access network to a computing device;
determining the selected amount of the programming popularity information; and
providing the selected amount of the programming popularity information over the access network to the computing device.

15. The method of claim 14, wherein the providing the selected amount of programming popularity information includes transmitting the selected amount of programming popularity information via an Internet Protocol (IP) channel over the access network.

16. The method of claim 14, wherein the displaying of the selection criteria comprises displaying at least one selectable option to view at least one of programming popularity information for a selected number of programs, programming popularity information for a selected program type, programming popularity information for a selected video channel, programming popularity information for a selected date range, programming popularity information for a selected time range, historical popularity information, and real-time popularity information.

17. The method of claim 14, wherein the determining of the selected amount of programming popularity information includes determining the selection criteria, and producing the selected amount of programming popularity information from the received programming popularity information using the selection criteria.

18. A method comprising:
providing an interactive program guide containing program guide information for a plurality of video programs available over an access network to a display device for viewing by a user;
displaying selection criteria for selecting a portion of the programming popularity information;
receiving a first request for programming popularity information associated with at least one of the plurality of video programs;
transmitting a second request over the access network, the second request indicating the requested programming popularity information;
receiving the programming popularity information;
determining the selected portion of the programming popularity information using the selection criteria; and
providing the selected portion of the programming popularity information to the display device.

19. The method of claim 18, wherein the providing of the programming popularity information to the display device includes identifying at least some of the plurality of video programs by title and popularity relative to other video programs.

20. The method of claim 18, wherein the providing of the programming popularity information to the display device comprises overlaying the selected portion of the programming popularity information over an image generated by a video signal to the display device.

21. (canceled)

22. The method of claim 18, wherein the displaying of the selection criteria comprises displaying at least one selectable option to view at least one of programming popularity information for a selected number of programs, programming popularity information for a selected program type, programming popularity information for a selected video channel, programming popularity information for a selected date range, programming popularity information for a selected time range, historical popularity information, and real-time popularity information.
